(19) United States
(12) Patent Application Publication
(10) Pub. No.: US 2026/0254209 A1
(43) Pub. Date: Aug. 27, 2026

(54) Monitoring Pole Discrepancies in Switchgear

(71) Applicant: Saudi Arabian Oil Company, Dhahran (SA)

(72) Inventors: Amar Patel, Dhahran (SA); Rohit Birla, Al Khobar (SA); Ho Jin Pang, Dhahran (SA); Jaafar Al Sheef, Al Qatif (SA)

(21) Appl. No.: 19/061,451

(22) Filed: Feb. 24, 2025

(51) Int. Cl. H02B 13/065

(52) U.S. Cl. CPC H02B 13/065

(57) ABSTRACT

Gas insulated switchgear for isolating a power system can include three individually poled breakers. A timer circuit actuated after a preset time delay in response to a discrepancy in position of the three individually poled breakers can include three contacts, each contact associated with one of the three individually poled breakers. A supervisory relay can include a status lamp, a first normally open contact connected to the status lamp, a circuit breaker closing coil, and a second normally open contact connected to the circuit breaker closing coil, the supervisory relay connected to the timer circuit such that power to the timer circuit closes the first and the second normally open contacts.

### TECHNICAL FIELD

This specification generally relates to Gas Insulated Switchgear (GIS), particularly for monitoring health of pole discrepancy schemes in single or individual pole operated GIS circuit breakers.

### BACKGROUND

GIS is a collection of circuit breakers, disconnectors, earthing switches, current and voltage transformers and other equipment that protects, controls, and isolates this electrical equipment in a power system in industries including electrical utilities and oil-and-gas plants. GIS circuit breakers can be used to regulate the flow of power, and to isolate circuits for maintenance or to clear faults downstream on initiation from a protection relay or other systems like pole discrepancy schemes. GIS circuit breakers can open automatically on a protection system command if there is any fault in the network, but typically also have a manual control override.

Gas Insulated Switchgear circuit breakers are categorized into two types: single-pole operation and three-pole operation. In single pole operation, each pole of the circuit breaker possesses its own independent mechanism, allowing it to operate autonomously from the other poles or phases. Typically, the phases are denoted as red, yellow, and blue, or alternatively as L1, L2, and L3.

Conversely, in three-pole circuit breakers, all three poles are linked to a common shaft, and a single operating mechanism drives all the poles simultaneously. These breakers, also known as gang-operated breakers, ensure that all three poles are always operated together through a single operating rod, eliminating the possibility of any single pole remaining open or closed.

For high voltage applications above 230 kV, the GIS circuit breakers are predominantly of single pole type to achieve single or multi-pole auto reclosing, controlled switching of poles and to have higher energies for make or break operations and in such a use case the pole discrepancy phenomenon is inevitable. In single pole operated circuit breakers, due to the separate mechanisms for each pole, there is a potential for pole discrepancies to occur. For instance, during the closing command, one pole may remain open while the other two closes, or vice versa. Such discrepancies, termed pole discrepancies, must be promptly addressed to prevent adverse effects on the system.

### SUMMARY

This specification describes an approach to monitoring pole discrepancy schemes in GIS to check that a pole discrepancy protection system of the switchgear is active before the circuit breaker closing is attempted. Pole discrepancy protection systems are employed to prevent discrepancies in the position (Open/Close) between the poles/phases of a circuit breaker and to ensure that all the poles are opening and closing simultaneously within the predefined safe time. In one example of this approach, High Voltage Gas Insulated Switchgears rated 230 kV and above are equipped with three phase SF6 circuit breakers. The circuit breakers are installed as individual phases or poles, and their opening and closing are controlled by their own dedicated operating mechanism. According to IEC 62271-100 and ANSI C37.04-1999, when no special requirement with respect to simultaneous operation of poles is stated, the maximum difference during opening shall not exceed ⅙ of a cycle of rate frequency and during the closing shall not exceed ¼ of a cycle of rate frequency as well to prevent a phenomenon called ferro-resonance which causes the development of damaging overvoltage for the downstream equipment. The pole discrepancy protection monitoring system is configured to inform the switching operator, prior to switching that the pole discrepancy scheme is active and working. The monitoring system can prevent undesired successive C-O operation as the operator will not attempt to perform any switching if the pole discrepancy protection is not activated.

The approach described in this specification is to modify the pole discrepancy scheme to have an indicator (e.g., a lamp) which will clearly indicate to the system operator that the pole discrepancy scheme is functioning and healthy before the operator performs closing of the circuit breaker. Some pole discrepancy protection monitoring systems also include a supervision relay to block the breaker closing operation automatically if the pole discrepancy function is out of order which will act as a safety interlock preventing circuit breaker closing on faulty pole discrepancy protection.

The approach described in this specification can provide one or more of the following advantages. The described approach informs the system operator beforehand about healthiness of the pole discrepancy scheme before closing the circuit breaker. It also can lock out breaker close operation upon detection of defects in the pole discrepancy protection. Preventing breaker close operations during pole discrepancy scheme is defective protects downstream equipment from damaging transient overvoltage due to ferro-resonance.

A major consequence of a pole discrepancy is the flow of unbalanced current into the ground, leading to system instability. If one or two poles exhibit discrepancies, asymmetrical currents flow through the network, further exacerbating system instability and potentially causing cascading failures to downstream equipment by the means of phenomenon like ferro resonance which also causes excessive over voltages.

This approach can also reduce the likelihood of a mismatch in the operation of the individual poles of a multi-pole circuit breaker. For example, in a three-pole circuit breaker, one pole may trip while the others do not. By reducing the likelihood of a mismatch, this approach can reduce the likelihood of unbalanced conditions in the electrical system causing equipment damage or safety hazards.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1A is a perspective view of a high voltage gas insulated switchgear.

FIG. 1B is a front view of the local control console of the high voltage gas insulated switchgear of FIG. 1A.

FIG. 2A shows the default configuration of a pole discrepancy monitoring protection and a pole discrepancy protection monitoring system.

FIG. 2B shows the pole discrepancy monitoring protection and the pole discrepancy protection monitoring system with circuit breaker open.

FIG. 2C shows the pole discrepancy monitoring protection and the pole discrepancy protection monitoring system with circuit breaker closed.

FIG. 2D shows the pole discrepancy monitoring protection and the pole discrepancy protection monitoring system with a pole discrepancy.

Like reference symbols in the various drawings indicate like elements.

### DETAILED DESCRIPTION

This specification describes an approach to monitoring pole discrepancies in switchgear that a pole discrepancy protection system of the switchgear is active. Pole discrepancy protection systems are employed to prevent discrepancies in the position (Open/Close) between the poles/phases of a circuit breaker and to ensure that all the poles are opening and closing simultaneously within the predefined safe time. In one example of this approach, High Voltage Gas Insulated Switchgears rated 230 kV and above are equipped with three phase SF6 circuit breakers. The circuit breakers are installed as individual phases or poles, and their opening and closing are controlled by their own dedicated operating mechanism. The closing and opening of all three poles within 2 milliseconds as per IEC 62271-203 is required to prevent a phenomenon called ferro-resonance which causes the development of damaging overvoltage for the downstream equipment. The pole discrepancy protection monitoring system is configured to inform the switching operator, prior to switching that the pole discrepancy protection, that is activated. The monitoring system can prevent undesired successive close-open operation as the operator will not attempt to perform any switching if the pole discrepancy protection is not activated.

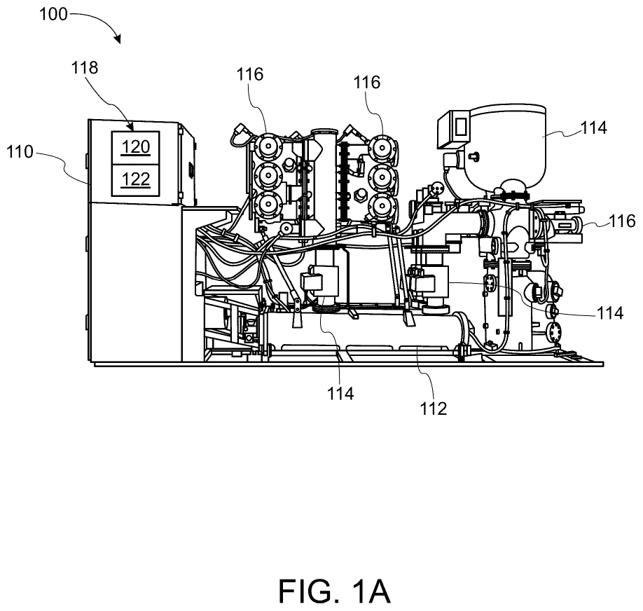

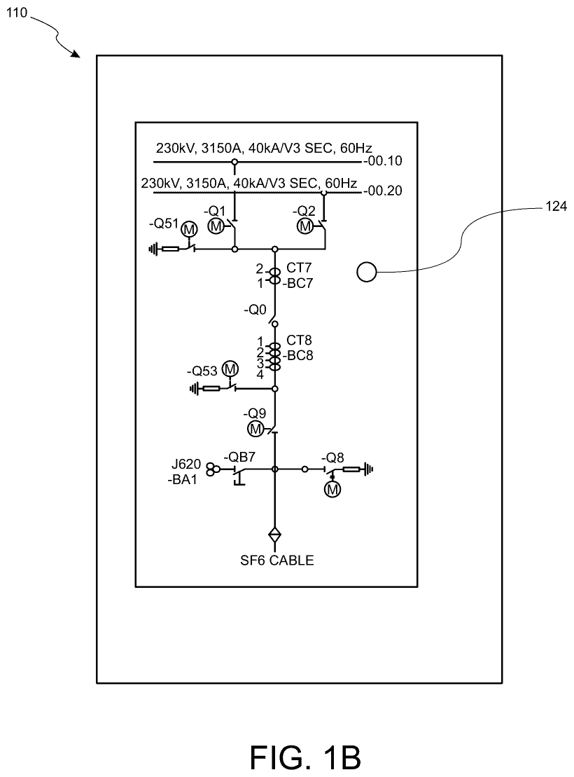

FIG. 1A is a perspective view of a switchgear 100. FIG. 1B is a front view of the local control cabinet 110 of the switchgear 100 of FIG. 1A.

The switchgear 100 includes the local control cabinet 110, circuit breakers 112, voltage and current transformers 114, disconnectors and earthing switches 116, and control and protection circuitry 118. The control and protection 118 installed in the local control cabinet 110 includes the pole discrepancy protection 120 and the pole discrepancy protection monitoring system 122.

The circuit breakers 112 of the switchgear 100 are three phase SF6 circuit breakers. The circuit breakers 112 are installed as individual phases or poles, and their opening and closing are controlled by their own dedicated operating mechanisms. The closing and opening of all three poles within 2 milliseconds as per IEC 62271-203 are required to prevent a phenomenon called ferro-resonance which causes the development of damaging overvoltage for the downstream equipment. The pole discrepancy protection monitoring system 122 is configured to inform the switching operator, prior to switching, that the pole discrepancy protection 120 is activated. The monitoring system 122 can prevent undesired successive close-open operation as the operator will not attempt to perform any switching if the pole discrepancy protection 120 is not activated.

The pole discrepancy protection monitoring system 122 includes an indicator e.g., a lamp 124 shown on FIG. 1B) which will clearly indicate to the system operator that the pole discrepancy protection 120 is functioning before the operator performs closing of the circuit breaker 112. The pole discrepancy protection monitoring system 122 also includes a supervision relay to block the breaker closing operation automatically if the pole discrepancy protection 120 is out of order. This supervision relay acts as a safety interlock preventing circuit breaker 112 closing with faulty pole discrepancy protection 120.

A spring operating mechanism is used to open or close the circuit-breakers 112. The closing latch generates the energy required to close the circuit-breaker and charges the opening latch. The mechanical energy required for opening is stored in the opening latch when the circuit-breaker is closed. A motor automatically reloads the closing latch after closing.

The disconnectors 114 provide a safe insulating gap to isolate sections with different potential. The operating mechanism of the disconnector and earthing switch is mounted in the drive cubicle at the front of the bay and contains all the components needed for operation and is wired to the integrated local control cabinet 110e next to it.

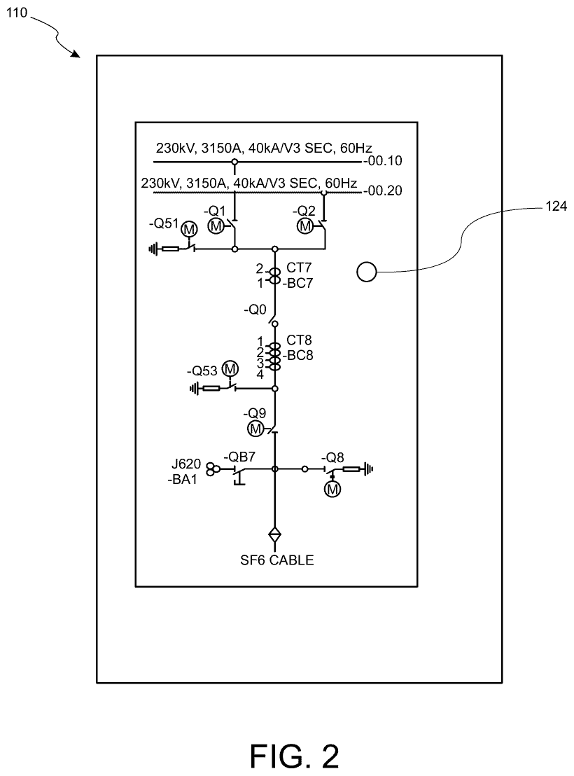

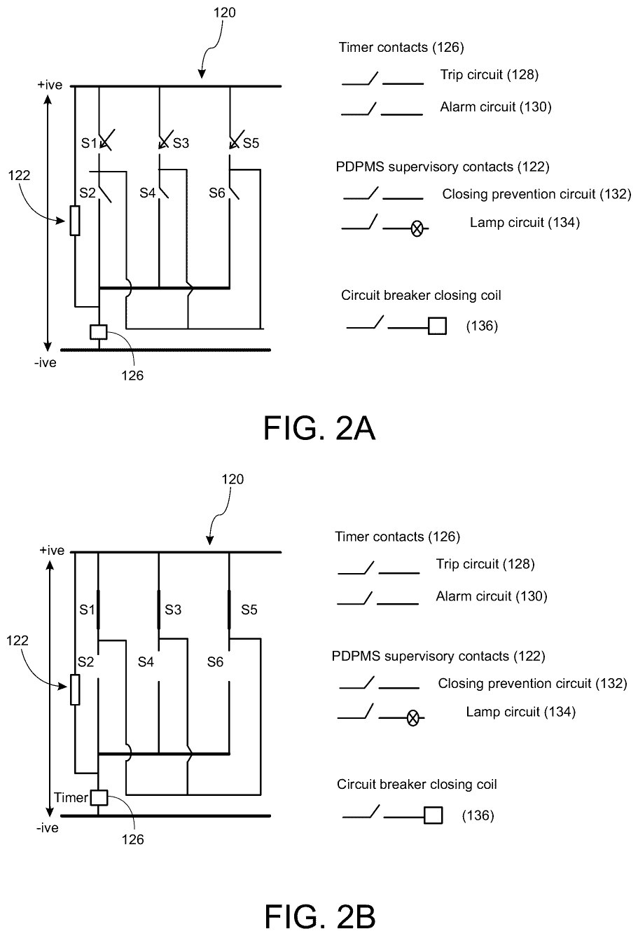

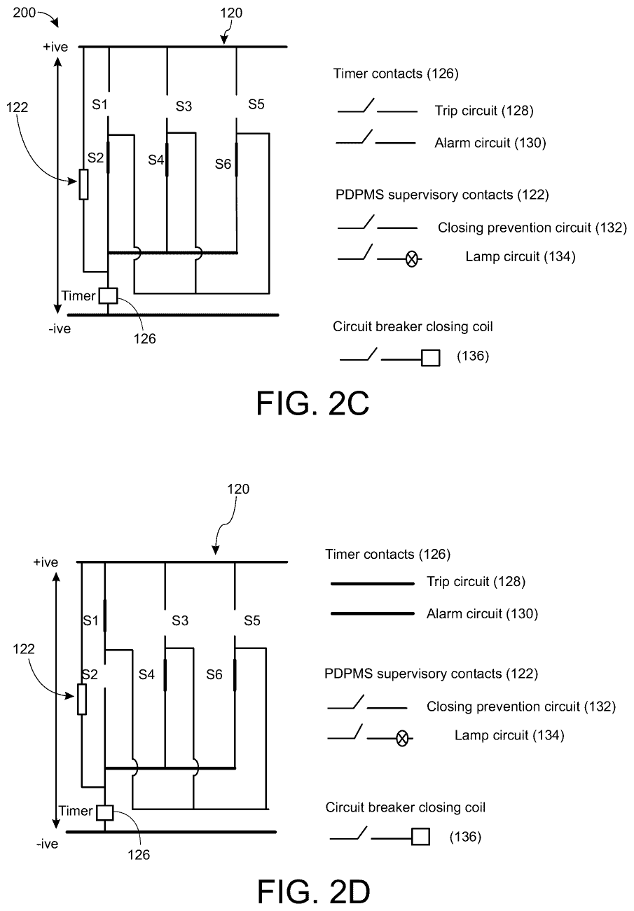

FIG. 2A shows the default configuration of the pole discrepancy protection 120 and the pole discrepancy protection monitoring system 122. The pole discrepancy protection 120 is configured to ensures that all the three poles of circuit breaker are tripped within a predefined time period. If there is a mismatch, pole discrepancy protection 120 will operate and will trip all the three poles of the breaker.

The pole discrepancy protection 120 includes 6 breaker auxiliary contacts (S1, S2, S3, S4, S5, and S6) associated with physical opening and closing of the circuit breaker. The breaker auxiliary contacts include both normally closed contacts (S1, S2, and S3) and normally closed contacts (S4, S5, and S6). Matched sets of normally open and normally closed contacts are associated with each pole. The pole discrepancy protection 120 also includes a timer 126 with a trip circuit 128 (normally open) and an alarm circuit 130 (normally open).

The pole discrepancy protection monitoring system 122 includes a coil supervision relay 123 which has a closing prevention contact 132 and a lamp contact 134. Both the closing prevention contact 132 and the lamp contact 134 are normally open. The coil supervision relay monitors the healthiness of pole discrepancy timer 126 as it is energized until the timer 126 is healthy.

When the timer 126 is functional, the coil supervision relay 123 is energized as it gets power and the closing prevention contact 132 and the lamp contact 134 are closed. Closure of the closing prevention contact 132 allows a circuit breaker closing coil 136 to be energized when operator intends to close the circuit breaker and the lamp contact illuminates an external lamp showing the operator that the pole discrepancy scheme is healthy/functional. If the timer 126 is not functional, the closing prevention contact 132 will be open blocking the DC supply from reaching to circuit breaker coil 136 and preventing closing of the circuit breaker and the lamp circuit (134) will be off alerting the operator of that the Pole Discrepancy system is non-functional and needs to be fixed before closing of the Circuit Breaker.

FIG. 2B shows the pole discrepancy monitoring protection and the pole discrepancy protection monitoring system with circuit breaker open. FIG. 2C shows the pole discrepancy monitoring protection and the pole discrepancy protection monitoring system with circuit breaker closed. FIG. 2D shows the pole discrepancy monitoring protection and the pole discrepancy protection monitoring system with a pole discrepancy.

If all poles are open (FIG. 2B) or closed (FIG. 2C), all of the matched sets (S1/S2, S3/S4, and S5/S6) of normally open and normally closed contacts are associated with each pole are in the same configuration. When all of the matched sets are in the same configuration, there is not a closed path through breaker auxiliary contacts (S1, S2, S3, S4, S5, and S6) to the timer 126. When there is a pole discrepancy, not all of the matched sets (S1/S2, S3/S4, and S5/S6) of normally open and normally closed contacts are associated with each pole are in the same configuration. When this occurs, the positive supply reaches the timer 126 through the breaker auxiliary contacts initiating the timer 126. After the timer 126 is still active for a set period of time, the timer closes the trip circuit 128 providing a trip command to all the three poles of the circuit breaker. The timer simultaneously closes the alarm circuit 130 alerting operators to fault condition.

FIG. 2D shows the pole discrepancy monitoring protection and the pole discrepancy protection monitoring system with a pole discrepancy in which the first pole of the circuit breaker is open and the second and third poles are closed. Current flows through normally closed breaker auxiliary contact associated with the first pole (S1), through the bypass line and the normally open breaker auxiliary contact associated with the second pole (S4) and the third pole (S6) to the timer 126.

### EXAMPLES

In some implementations, a switchgear for isolating a power system includes: three individually poled breakers; a timer circuit actuated after a preset time delay in response to a discrepancy in position of the three individually poled breakers, the timer circuit comprising three contacts, each contact associated with one of the three individually poled breakers; and a supervisory relay comprising a status lamp, a first normally open contact connected to the status lamp, a circuit breaker closing coil, and a second normally open contact connected to the circuit breaker closing coil, the supervisory relay connected to the timer circuit such that power to the timer circuit energizes the supervisory relay and closes the first and the second normally open contacts.

In some implementations, a switchgear for isolating a power system includes: a plurality of individually poled breakers; a timer circuit actuated after a preset time delay in response to a discrepancy in position of the individually poled breakers, the timer circuit comprising a plurality of contacts, each contact associated with one of the individually poled breakers; and a supervisory relay comprising a status indicator, a first normally open contact connected to the status indicator, a circuit breaker closing coil, and a second normally open contact connected to the circuit breaker closing coil, the supervisory relay connected to the timer circuit such that power to the timer circuit closes the first and the second normally open contacts.

In an example implementation combinable with any other example implementation, the switchgear is rated at 230 kV or more. In some cases, the breakers are three-phase individual/single pole operated SF6 circuit breakers.

In an example implementation combinable with any other example implementation, the preset time delay of the timer circuit is less than 1 second. In some cases, the preset time delay of the timer circuit is less than 0.1 seconds.

In an example implementation combinable with any other example implementation, the circuit breaker closing contact of the supervisory relay prevents closing of the breakers when the timer circuit is not operational.

In an example implementation combinable with any other example implementation, the switchgear also includes six breaker auxiliary contacts associated with physical opening and closing of the circuit breaker.

In an example implementation combinable with any other example implementation, the timer circuit further comprises with a third normally open contacts wired to a trip circuit configured to force open the circuit breaker in case of a pole discrepancy and a fourth normally open contacts wired to an alarm circuit configured to generate an alarm in the event that the pole discrepancy has occurred.

In an example implementation combinable with any other example implementation, the status indicator comprises a lamp.

A number of embodiments of the systems and methods have been described. Nevertheless, it will be understood that various modifications may be made without departing from the spirit and scope of this specification. Accordingly, other embodiments are within the scope of the following claims.

What is claimed is:

1. A switchgear for isolating a power system, the switchgear comprising:
three individually poled breakers;
a timer circuit actuated after a preset time delay in response to a discrepancy in position of the three individually poled breakers, the timer circuit comprising three contacts, each contact associated with one of the three individually poled breakers; and
a supervisory relay comprising a status lamp, a first normally open contact connected to the status lamp, a circuit breaker closing coil, and a second normally open contact connected to the circuit breaker closing coil, the supervisory relay connected to the timer circuit such that power to the timer circuit energizes the supervisory relay and closes the first and the second normally open contacts.

2. The switchgear of claim 1, wherein the switchgear is rated at 230 kV or more.

3. The switchgear of claim 2, wherein the breakers are three-phase individual/single pole operated SF6 circuit breakers.

4. The switchgear of claim 1, wherein the preset time delay of the timer circuit is less than 1 second.

5. The switchgear of claim 1, wherein the circuit breaker closing contact of the supervisory relay prevents closing of the breakers when the timer circuit is not operational.

6. The switchgear of claim 1, further comprising six breaker auxiliary contacts associated with physical opening and closing of the circuit breaker.

7. The switchgear of claim 1, wherein the timer circuit further comprises with a first normally open contactsr wired to a trip circuit configured to force open the circuit breaker in case of a pole discrepancy and a second normally open contacts wired to an alarm circuit configured to generate an alarm in the event that the pole discrepancy has occurred.

8. A switchgear for isolating a power system, the switchgear comprising:
a plurality of individually poled breakers;
a timer circuit actuated after a preset time delay in response to a discrepancy in position of the individually poled breakers, the timer circuit comprising a plurality of contacts, each contact associated with one of the individually poled breakers; and
a supervisory relay comprising a status indicator, a first normally open contact connected to the status indicator, a circuit breaker closing coil, and a second normally open contact connected to the circuit breaker closing coil, the supervisory relay connected to the timer circuit such that power to the timer circuit closes the first and the second normally open contacts.

9. The switchgear of claim 8, wherein the status indicator comprises a lamp.

10. The switchgear of claim 8, wherein the switchgear is rated at 230 kV or more.

11. The switchgear of claim 10, wherein the breakers are three-phase individual/single pole operated SF6 circuit breakers.

12. The switchgear of claim 8, wherein the preset time delay of the timer circuit is less than 1 second.

13. The switchgear of claim 8, wherein the circuit breaker closing contact of the supervisory relay prevents closing of the breakers when the timer circuit is not operational.

14. The switchgear of claim 8, further comprising six breaker auxiliary contacts associated with physical opening and closing of the circuit breaker.

15. The switchgear of claim 8, wherein the timer circuit further comprises with a first normally open contacts wired to a trip circuit configured to force open the circuit breaker in case of a pole discrepancy and a second normally open contacts wired to an alarm circuit configured to generate an alarm in the event that the pole discrepancy has occurred.
